(19) United States
(12) Patent Application Publication
(10) Pub. No.: US 2003/0065934 A1
(43) Pub. Date: Apr. 3, 2003

(54) After the fact protection of data in remote personal and wireless devices

(76) Inventors: Michael F. Angelo, Houston, TX (US); Manuel Novoa, Houston, TX (US); Sompong P. Olarig, Pleasonton, CA (US)

Correspondence Address: CONLEY ROSE, P.C., P. O. BOX 3267, HOUSTON, TX, 77253-3267, US

(21) Appl. No.: 09/965,960

(22) Filed: Sep. 28, 2001

(51) Int. Cl. G06F 12/14

(52) U.S. Cl. 713/200; 713/176

(57) ABSTRACT

A security system is provided which permits a user or owner of a portable electronic device to report the device missing to a security station. In response, the security station wirelessly transmits a security message or command to the portable electronic device which, in turn, responds by causing a “destructive” security action to occur. The destructive action may include erasing memory in the portable device, disabling certain functions (e.g., transmitting data, receiving data, accessing memory, etc.) or other types of actions such as reporting location information to the security station. Various security mechanisms can be implemented as well to minimize the risk that an unauthorized entity will be able to broadcast security messages to portable devices.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to computer security. More particularly, the invention relates to security in a remote computer device. Still more particularly, the invention relates to broadcasting an authenticated security message to a remote computer device upon its theft to cause the computer device to protect its data.

2. Background of the Invention

Numerous innovations have been made in the computer arts. For example, wireless portable devices such as laptop computers, handheld personal data assistants (“PDAs”), wireless email devices, and the like have made it easy to perform computer tasks (e.g., word processing, email, etc.) virtually anywhere. Improvements in miniaturization have resulted in portable computer devices that are very small with some being no larger than a common pager.

As with anything small and valuable, theft has increasingly become a problem for wireless portable computer-type devices. The value of portable device lies in the hardware itself as well as any information stored on the device. In fact, in many cases the value of the information stored on the device or the information to which the device has access may far outweigh the cost of the hardware. The information stored on or accessible to the device may contain highly sensitive information pertaining to an individual or an organization.

Thus, an authenticated security mechanism is needed for such devices. One proposed attempt to provide security has been to remotely activate a password feature in the device. That is, a wireless message is sent which causes the stolen device to enable a password that, until a valid password is entered, precludes further use of the device. Although generally acceptable, this type of security response results in the sensitive information remaining in the device. A clever enough thief might be able to bypass the password protection, or discovery or guess the password, and get at the sensitive information nonetheless.

Some PDAs today (as well as other types of devices such as cell phones, pagers, etc.) include a security mechanism which requires a user to enter a valid password, such as a 4 digit personal identification number (“PIN”) before accessing the capabilities of the device. The device will lock itself if a predetermined number of invalid PINs are entered. The idea is that if someone attempts to access the device by simply guessing passwords, the device will time out before the person is likely to guess a correct password. If the device times out and locks itself from any further access attempts, sensitive information, nevertheless, still remains stored in the device's memory and literally in the hands of an unauthorized person. Further, because the password is set to come on after a period of inactivity, the password is inconvenient and complicates use of the device. Most users, in fact, fail to enable the password feature. As a result, many such portable devices are unprotected. On some devices, a protection mechanism exits whereby if the password feature is enabled, the device will lock up after 10 invalid password attempts and even delete contents of memory. This mechanism works only if the user has enabled the password. This security mechanism is useless if the user has not enabled the password. If the password is not enabled on a device, any user (including unauthorized users) of the device will have access to sensitive information contained therein.

These types of security features are useful in their own right, but there is room for improvement. Accordingly, a security feature is needed which addresses the shortcomings of the techniques noted above.

### BRIEF SUMMARY OF THE INVENTION

The problems noted above are solved in large part by permitting a user or owner of a portable electronic device to report the device missing to a “security station.” In response, the security station transmits a security message or command to the portable electronic device which, in turn, responds by causing a “destructive” security action to occur. The destructive action may include erasing memory in the portable device, disabling certain functions (e.g., transmitting data, receiving data, accessing memory, etc.) or other types of actions such as reporting location information to the security station.

In accordance with the preferred embodiment, the security station comprises an entity, which can be a computer or collection of networked computers (i.e., a “data center”), to which a person can contact to report a portable device missing. The portable device preferably wirelessly communicates with the security station. The security station preferably verifies the authenticity of the person reporting the missing device, and if the person passes the verification process, the security station generates and transmits the security message to the portable device. The portable device responds to the security station by performing one or more destructive actions.

Additionally, other security features can be incorporated to minimize the risk for an unauthorized entity to determine how to send security messages to the various portable devices. For example, the security station may digitally sign the security message using a private “key” associated with the person reporting the device missing. Upon receiving the signed message, the portable device verifies the signature and performs the destructive action. The security message itself may be encrypted if desired. Numerous other types of security mechanisms can be put in place such as permitting a user to abort the destructive security action, permitting a user of the portable device to perform tasks on the device for a specified period of time before the destructive action is performed. These and other security mechanisms are described in detail in the following section.

### BRIEF DESCRIPTION OF THE DRAWINGS

For a detailed description of the preferred embodiments of the invention, reference will now be made to the accompanying drawings in which:

FIG. 1 shows a block diagram of a security system usable in connection with a security station and one or more portable electronic devices; and

FIG. 2 shows a more detailed schematic of the block diagram of FIG. 1.

### NOTATION AND NOMENCLATURE

Certain terms are used throughout the following description and claims to refer to particular system components. As one skilled in the art will appreciate, computer companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. To the extent that any term is not specially defined in this specification, the intent is that the term is to be given its plain and ordinary meaning.

### DETAILED DESCRIPTION OF THE PREFERRED EMBODIMENTS

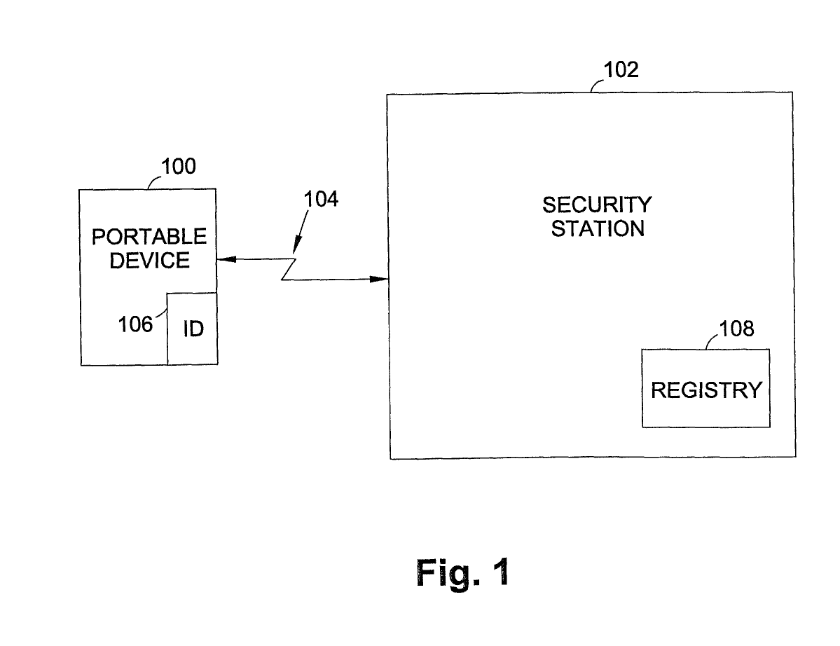

Referring now to the figures, FIG. 1 is presented to broadly illustrate the principles underlying the preferred embodiment. FIG. 1 shows a portable device 100 and a security station 102 in accordance with the preferred embodiment of the invention. As shown, portable device 100 and security station 102 are in communication with one another via communication link 104. In accordance with the preferred embodiment, the communication link 104 may comprise a wireless link or, if desired, a wire-based link. In general, multiple portable devices 100 may be operatively coupled to security station 102, although only one is shown in FIG. 1.

The portable device 100 may comprise any type of portable electronic devices such as personal data assistants (“PDAs”), laptop computers, pagers, and the like. In general, device 100 comprises any type of device that conceivably may fall into the possession of an unauthorized person or entity and that may contain sensitive information that should be protected from unauthorized access. The security station 102 preferably comprises one or more pieces of electronic equipment that can send and, if desired, receive messages to/from portable device 100. For example, security station 102 may be an individual computer or a data center comprising a plurality of computers. In one embodiment, security station 102 may comprise an application service provider (“ASP”) on the web and communication link 104 may comprise a wireless Internet connection.

In accordance with a normal scenario, an “authorized person” owns or possesses the portable device 100 or otherwise has permission to use the portable device and access the information contained therein. In the event the portable device 100 is stolen by an “unauthorized person” or otherwise is misplaced or stolen, the authorized person can contact the security station 102 to initiate a security procedure. The authorized person identifies the portable device 100 to the security station 102 using a unique identifier (“ID”) 106. The unique identifier 106, which is stored in portable device 100, provides a mechanism by which security station 102 can communicate with the device as opposed to all other portable devices 100. The identifier 106 may be any type of uniquely identifying value, such as an Internet Protocol (“IP”) address or a wireless ESN number, that the security station 102 can use to conduct a private communication. As shown in FIG. 1, the security station 102 preferably includes a registry 108 in which one or more portable devices 100 can be registered. Each registration may include various fields of information such as the device's ID value. The security station uses the ID value to determine how to initiate a message transfer to the targeted portable device. Any suitable manner for the security station 102 to determine how to communicate with the specific portable device based on the ID value is acceptable. For example, the ID value may comprise the portable device's address or the address may be a separate piece of information in the registry 108 associated with the ID. The security station 102 would then use the address to communicate with the device. Other information captured in the registry for a portable device may include device type, authorized person's name and address, and the like.

Once the authorized person identifies to the security station 102 the identity of a particular device 100 that may be in a comprised situation (i.e., lost or stolen), the security station preferably performs a security procedure that causes a “destructive” action to occur on the portable device 100. To this end, the security station 102 transmits a security message to the portable device 100 over communication link 104 to cause the destructive action to occur. The portable device 100 preferably interprets the security message and performs a destructive action that has been predetermined or specified in the security message itself.

A “destructive” action generally refers to one of several types of actions. The first type of destructive action is one in which certain information stored in the portable device 100 is simply erased. An example of this type of destructive action may entail the portable device 100 erasing all of its internal memory (i.e., a “reset”). Alternatively, the destructive action could include erasing only a portion of the device's internal memory, such as a portion that may be allocated for storing information deemed to be more sensitive than data in other portions of memory. These types of destructive action prevent recovery of the information by even the authorized person.

The second type of destructive action is one in which one or more functions of the portable device 100 are disabled, but can be reactivated if desired. For example, the portable device 100 might place itself into a mode in which it can receive messages, but cannot transmit or release information for use by other devices. Alternatively, the portable device might transition to a mode in which it can be used to transmit messages, but the contents of its memory cannot be accessed. In general, this type of destructive action causes the portable device to function for an unauthorized person in such a way that would be acceptable to the authorized person given that the device may be in the hands of an unauthorized person. Another action might be to simply lock the machine down while displaying a pre-defined message with a return address for the device or a telephone number to call.

It should be noted that instead of, or in addition to, a destructive action, other types of security actions could be implemented as well. For example, the portable device 100 could be equipped with a well-known global positioning system (“GPS”) receiver (not specifically shown in FIG. 1). The security message from the security station 102 might be for the portable device 100 to report its location to the security station. Further, a portion of the device's hardware may be destroyed, such as by tripping a switch to short out circuitry. Alternatively, the destructive action may include running memory at an incorrect clock rate (either too slow or too fast).

It should be noted also that, if the registry 108 includes a portable device type field for each registered device, the security station 102 can initiate a specific type of security action based on the type of portable device identified. For example, the security station 102 might transmit one type of security message to a PDA and a different security message to a laptop computer. In this manner, different types of portable devices may respond to security problems in different ways. Alternatively or additionally, the security station may simply transmit a basic security message to any type of portable device and each type of portable device may be pre-programmed to perform a desired security action.

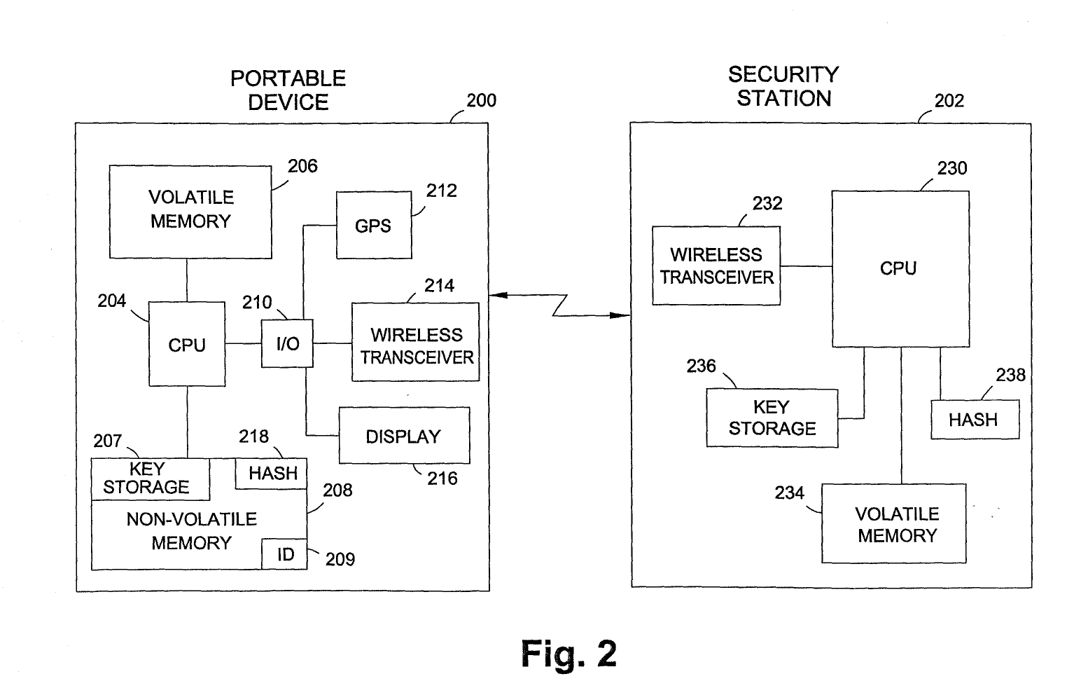

A more specific implementation of the preferred embodiment of the invention is shown in FIG. 2. As shown, portable device 200 preferably includes a central processing unit (“CPU”) 204, a volatile memory 206, a non-volatile memory 208, an input/output (“I/O”) module 210, a GPS receiver 212, a wireless transceiver 214, and a display 216. The aforementioned components and the way in which they are connected as shown in FIG. 2 are not required. Not all of the componets shown as comprising portable device 200 need be included (e.g., GPS receiver 212) and it should be recognized that other components (e.g., a battery) may be included that are not shown in FIG. 2.

Generally, the CPU 204 controls the operation of the portable device 200. The CPU may read from and write to volatile memory 206 (which preferably comprises RAM memory). The CPU 204 may also access non-volatile storage 208. The CPU 204 may coordinate the transfer of information between it and the security station 202 via I/O module 210 and wireless transceiver 214. A display 216 may be included to permit a person to use the device 200. In the form of a PDA, the display 216 preferably comprises a touch sensitive liquid crystal display (“LCD”) with which a stylus (not shown) can be used as an input device. GPS transceiver 212 may also be included to provide location information as noted above with regard to FIG. 1.

The security station 202 may be a computer as shown or a collection of computers coupled together to form a data center. As a computer, security station 202 may include a CPU 230, a wireless transceiver 232, volatile memory 234, key storage 236 and a hash function 238. One of ordinary skill in the art will recognize that many other components may be included in security station 202 as well. The system shown in FIG. 2 generally functions as described above with regard to FIG. 1. An authorized person can identify a portable device 200 (presumably one that is missing) by its ID 209 (which may be stored in non-volatile memory 208). The security station 202 responds by transmitting a security message to the portable device 200 which may respond destructively as explained above, such as by erasing all or a portion of volatile memory 206, precluding access to data stored on memory 206 or 208, providing location information from GPS 212 and the like.

Several other features may be incorporated into the security system described herein for portable devices. For example, if an unauthorized individual was to intercept the security message transmitted from the security station to the portable device, that individual might then know how to sabotage other portable devices by commanding them to erase their data or perform some other type of security action. Thus, it may be preferred for the security station 202 to send the security message in any suitable form that is safe from unauthorized persons or entities. Doing so will frustrate, if not preclude, an unauthorized person from intercepting the security message and being able to determine how to send such security messages.

For instance, the security message may be digitally “signed” using any one of a variety of authentication techniques, now known or later developed. As is well known to those of ordinary skill in the art, most digital signature techniques involve the use of a “hash” function and an encryption “key.” Thus, as shown in FIG. 2, portable device 200 and security station 202 include key storages 207, 236, and hash functions 218 and 238. The key storage 207 in the portable device 200 preferably is part of the non-volatile memory 208 and preferably, in accordance with known hardware and/or software techniques, cannot be overwritten or copied. The key storage 236 in the security station 202 preferably is part of some type of non-volatile memory and may, for example, be a “smart card” or other type of removable, non-volatile memory media. The hash function 238 also is stored in non-volatile memory. The registry information explained above with respect to FIG. 1 may be included as part of key storage 236 with each user's key being associated with that user and their portable device.

In accordance with preferred embodiment, the portable device's key storage includes a public key and the corresponding private key is stored in the security station's key storage 236. Then, when the authorized person looses or misplaces their portable device 200, that person contacts the security station 202 via a telephone call to a person or over a network such as the Internet. The security station 202 then verifies that the authorized person is, in fact, authorized to cause the security station 202 to issue a security message to the missing portable device 200. The technique for verifying the person desiring the security station to issue a security message can be in accordance with any suitable type of verification protocol, such as answering a secret question, providing a predetermined code word, biometrics (i.e., the person's fingerprint, voice, iris scan, etc. is digitized and sent to the security station for verification), and the like.

Upon successfully verifying the person requesting the transmission of a security message to a portable device, the security station 202 signs the security message preferably with that person's private key stored in key storage 236. This may be accomplished by the CPU 230 retrieving and applying the “hash” function 238 (hash functions are well known in the art) to the security message to create a security message “digest.” Typically, a digest will be of a fixed size that is smaller than the message it is derived from, although this need not always be the case. The security station's CPU 230 then encrypts the security message digest using the private key to thereby sign the security message. The security station 202 transmits both the unencrypted security message and the encrypted security message digest to the portable device.

The portable device 200 receives the digitally signed security message, decrypts the message digest using the public stored in key storage 207 to recover the transmitted message digest, and also applies the same hash function used by the security station to the security message to independently create a message digest. It should be noted that, alternatively, a public key could be used by the security station 202 to sign the message with the portable device using a private key to verify the signature. The portable device then compares the message digest it independently computed to the message digest it recovered by decrypting the digest transmitted to it by the security station. If the two message digests match, the security message has been successfully authenticated. Upon authenticating the security message, the portable device's CPU 204 immediately proceeds to perform the desired security action. If, however, the portable device's CPU 204 cannot authenticate the digital signature, the portable device will not perform the requested security action. Furthermore, the portable device may respond back to the security station with appropriate status as to the failure of the requested security action and, if desired, the requested security action and its failure can be logged at the security station. In this way, an unauthorized person or entity (or at least a person without access to the correct private key) will not be able to cause a portable device to effectuate a security action and any unauthorized security action is logged at the security station.

In the event that a message is received by the portable device there are several actions that could be performed. As noted above, one action is to log the fact that an invalid message was received. Even upon receipt of a valid security message, some status may be sent to the security station to proactively advise what message was received by the portable device and that the desired action has been implemented. This also helps to ensure that if a “middle man” compromises the security station's private key for this device, this event can be detected and logged when the security station receives notification of a security action being performed that it did not request. After the security station logs the device's response to a particular message, the security station may decide to notify the device owner, generate new keys if, for example, status is received for an action that the station did not request or many failed messages to the device etc.

The security station and the portable device each may have their respective key pairs to further ensure privacy. For instance, two separate key pairs (one in the device and another in the security station) can be used such that one private/public key pair is used for encryption and the other for signing. Alternately, there could be a signing public/private key pair and a symmetric/shared key for encryption that may be negotiated between the security station and device. In addition, the security message itself may be encrypted with a private device key before or after the hash function is applied. As such, the hash function 238 may be applied to the unencrypted security message to create a message digest which is then encrypted. Then both the digital signature and the message are transmitted to the portable device. The portable device would then decrypt the message and the digest using its public device key, apply its own hash function 218 to the message and authenticate the signature by comparing the two digests. Alternatively, security station's CPU 230 may first encrypt the security message using the private device key (pₛₒ) key and then apply the hash 238 to the encrypted message to create the digest, which further is encrypted also using the security station's private key. The portable device 200 would then decrypt the encrypted message digest using the security station's public key, apply hash function 218 to the encrypted message, compare the two digests, and decrypt the security message using it's private decryption key if the signature is successfully verified.

In another embodiment, no digital signature is included and the security message is simply encrypted with a private device key at the security station 202 and transmitted to the portable device 200. The portable device uses its public device key to decrypt the security message and carry out the requested security action.

In another embodiment still, each user private key stored in the security station 202 and used to encrypt a security message may itself be encrypted with yet a different key. The encrypted private key on the security station would then require a key provided by the user simply to decrypt it so that the decrypted key(s) can be used to sign or encrypt a security message. In this way, additional security is provided which precludes the security station 202 from sending a security message without first receiving a key simply to be able to obtain the correct key needed to sign or encrypt the security message. This provides further assurance that an unauthorized person is unable to access the security station 202 and send out security messages to portable devices. Further still, encryption and signing keys can be encrypted separately for additional security.

Another concern that may also be addressed, if desired, is an unauthorized person that intercepts a security message to a particular device and then is able to retransmit that message to the same device at any time to cause the device to erase its memory. Accordingly, it is desirable to be able to prevent an undesired “replay” of a security message. To prevent such undesirable replays, the security station's CPU 230 preferably includes a unique value with the security message that the portable device uses to verify the message. Preferably, the unique value is different each time a security message is to be sent to the portable device. For example, the unique value could be a time stamp, a non-repeating sequence number, or a randomly generated number that only the authorized security station and the portable unit would know or be able to determine. The portable device thus uses the unique value to verify the authenticity of the security message. If an unauthorized person or entity were to intercept a security message, which has the aforementioned unique value, and attempts to send that same message, with the same unique value, the portable device will not verify the message because the unique value will be different than what the portable device expects.

Additionally, the encrypted security message could be one that would request the portable device to prompt the user for an abort key. The abort key can be any suitable type of abort key that presumably only an authorized use would know or have access to. If the user enters a correct abort key, the security action that would otherwise have occurred is aborted and the portable device continues its normal operation. If the abort key is not successfully verified, perhaps within a given amount of time, the portable device 200 proceeds to cause the security action to occur. The abort key can be verified in a variety of ways such as by the portable device 200 itself, using information contained within the security message transmitted by the security station, or by transmitting the abort key back to the security station 202 for verification by CPU 230.

A modification of the aforementioned technique would be to permit the user to execute a specified number of commands (either predetermined or programmable) on the portable device prior to the security action occurring. Further still, the portable device 200 may allow a specified amount of time to elapse before the security action occurs. During this specified time, the user could perform any functions or a limited set of functions on the portable device. Even further still, the security message could permit the portable device 200 to perform a certain number of tasks during a certain period of time. After either the specified number of tasks have been performed or the specified time period has expired, the portable device 200 would then perform the security action.

If desired, the security station's CPU 230 may cause the security message to be signed by the authorized user's private key noted above and then by a private key associated with the security station itself. The portable device would then have to verify the security message in light of both keys. Accordingly, even if the user's private key is stolen, a portable device still would not respond to a security message unless it can verify the security station's private key as well. This provides further security against a sabotager.

Further still, it may desirable to have more than one person or entity able to cause the security station to initiate a security response to a missing portable device 200. For example, an employer may assign a portable device to an employee. If the portable device is stolen or otherwise missing, it may be desirable for both the employee and employer to be able initiate a security response. In one embodiment, the employer and employee may simply use the same private key and be verified by the security station 202 using the same data. In this embodiment, the security station is unable to distinguish between the employer and employee and thus responds to the security station in the same way regardless of who initiated the response.

Alternatively, the employer and employee may have their own individual datum to verify themselves to the security station. In this way, the security station can distinguish between the employer and employee and, if desired, may be set to respond differently depending on who—employer and employee—initiated the response. To this end, the employer and employee may each be assigned a different public key-private key pair. The security station would then transmit the security message using any one or more of the aforementioned techniques and using the private key corresponding to the entity that reported the device 200 missing. The portable device 200 would then attempt to verify the security message with one public key and, if unable to verify the message with the first key, use the second public key to verify the message. In this way, the portable device would be able to determine whether the employer or employee reported the device missing and respond accordingly.

The individual security actions for the employer and employee can be any desired action. For example, an employer—initiated response might cause a complete erasure of all information in the portable device, whereas an employee—initiated response might only cause a partial erasure, or vice versa. Also, the security actions could be the same for both employer and employee.

Although the terms “employer” and “employee” were used in the preceding discussion, those terms should not be used to limit the disclosure to the employer-employee context. More broadly, one entity might simply be a “user” of the portable device and the other entity might be the “owner” of the device. More broadly still, one entity is a “first entity” and the other entity is a “second entity” without any specificity to the relationship between the two entities.

In summary, the aforementioned embodiments provides a technique to report a portable electronic device missing (stolen, lost, etc.) and a technique to transition the device to a mode in which sensitive information is inaccessible. Security techniques are implemented to reduce the risk that someone will “hack” in to the system to determine how to send out the security messages and then use that information to sabotage the portable devices.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for securing a portable electronic device, comprising:
(a) generating a security message;
(b) transmitting said security message to said portable electronic device;
(c) performing a destructive action on said portable electronic device in response to said security message.

2. The method of claim 1 wherein said destructive action includes erasing memory.

3. The method of claim 1 wherein said destructive action includes destroying a portion of said portable electronic device.

4. The method of claim 1 wherein said destructive action prevents said portable electronic device from transmitting or releasing information.

5. The method of claim 1 wherein (a) includes digitally signing said security message.

6. The method of claim 5 further including the portable electronic device verifying the digital signature.

7. The method of claim 5 using an encryption key to digitally sign the security message.

8. The method of claim 7 wherein said encryption key is stored in an encrypted form before being used to digitally sign the security message.

9. The method of claim 6 wherein a person or entity is authorized to cause (b) to happen and only that person or entity is capable of causing said encrypted key to be decrypted so as to be used to digitally sign the security message.

10. The method of claim 1 wherein (b) occurs after a request has been received to perform the destructive action.

11. The method of claim 10 wherein a person or entity is authorized to cause (b) to happen and (b) occurs after said requesting person or entity is verified.

12. The method of claim 1 further including encrypting the security message and said portable device decrypts the encrypted security message.

13. The method of claim 1 further including digitally signing said security message and including a unique value that changes each time (a) is performed.

14. The method of claim 13 further including receiving said digitally signed security message and authenticating the message using said unique value.

15. The method of claim 13 wherein said unique value includes a time stamp.

16. The method of claim 13 wherein said unique value includes a random number.

17. The method of claim 13 wherein said unique value includes a non-repeating sequence number.

18. The method of claim 1 further including permitting the destructive action to be aborted once the security message is received by said portable electronic device.

19. The method of claim 18 wherein permitting the destructive action to be aborted includes providing the portable electronic device with an abort key that is verified by the portable electronic device.

20. The method of claim 1 further including permitting a specified number of tasks to be performed by the portable electronic device before (c) is performed.

21. The method of claim 1 further including permitting tasks to be performed by said portable electronic device for a specified time period before (c) is performed.

22. The method of claim 1 further including permitting a specified number of tasks to be performed during a specified period of time and performing (c) after either said specified number of tasks have been performed or the specified time period has expired.

23. A portable electronic device, comprising:
a CPU;
a memory device coupled to said CPU;
a decryption key stored in said memory device;
an input/output (“I/O”) module coupled to said CPU which receives messages from an external security station;
wherein said CPU receives security messages from said security station via said I/O module and, in response, performs a destructive action.

24. The portable electronic device of claim 23 wherein said destructive action includes erasing said memory device.

25. The portable electronic device of claim 23 wherein said destructive action prevents said portable electronic device from transmitting information.

26. The portable electronic device of claim 23, wherein said security messages received at said I/O module include a digital signature and said CPU verifies the digital signature.

27. The portable electronic device of claim 26 wherein said CPU uses said decryption key to verify the digital signature.

28. The portable electronic device of claim 23 wherein said CPU verifies a unique value included in said security message, said unique value capable of being different each time the portable electronic device receives a security message.

29. The portable electronic device of claim 28 wherein said CPU authenticates the security message using said unique value.

30. The portable electronic device of claim 28 wherein said unique value includes a time stamp.

31. The portable electronic device of claim 28 wherein said unique value includes a random number.

32. The method of claim 28 wherein said unique value includes a non-repeating sequence number.

33. The portable electronic device of claim 23 wherein said CPU permits the destructive action to be aborted once the security message is received by said portable electronic device.

34. The portable electronic device of claim 33 wherein said CPU permits entry of an abort key to cause the destructive action to be aborted.

35. The portable electronic device of claim 23 wherein said CPU permits a specified number of tasks to be performed by the portable electronic device before performing said destructive action.

36. The portable electronic device of claim 23 wherein said CPU permits tasks to be performed for a specified time period before said destructive action is performed.

37. The portable electronic device of claim 23 wherein said CPU permits a specified number of tasks to be performed for a specified time period and, after either the specified number of tasks have been performed or the specified time period has elapsed, said CPU performs said destructive action.

38. The portable electronic device of claim 23 wherein said decryption key cannot be overwritten.

39. The portable electronic device of claim 23 wherein said decryption key cannot be copied.

40. A security station through which a user of a portable electronic device can initiate a security response associated with the portable electronic device, comprising:
a registry of user information accessible by said CPU and including an identifier value associated with the portable electronic device; and
a communication port to facilitate communication with the portable electronic device;
wherein said CPU generates a security message which is transmitted through the communication port to the portable electronic device to cause the portable electronic device to perform a destructive security action.

41. The security station of claim 40 wherein said CPU digitally signs said security message with a key associated with the user.

42. The security station of claim 41 wherein said CPU encrypts said security message with said key.

43. The security station of claim 40 wherein said CPU encrypts said security message with a key associated with the user.

44. The security station of claim 40 wherein said security message causes said portable electronic device to erase its data storage.

45. The security station of claim 40 wherein said security message causes said portable electronic device to cease transmitting data.

46. The security station of claim 40 wherein said security message causes said portable electronic device to preclude access to any stored in the portable electronic device.

47. The security station of claim 40 wherein said security message causes said portable electronic device to report location information to the security station.

48. The security station of claim 40 wherein said security message permits the portable electronic device to perform a specified number of tasks after which the portable electronic device performs s aid destructive action.

49. The security station of claim 40 wherein said security message permits the portable electronic device to perform tasks for a specified amount of time after which the portable electronic device performs said destructive action.

50. The security station of claim 40 wherein said security message permits the portable electronic device to perform a specified number of tasks for a specified amount of time, and after either the specified number of tasks have been performed or the specified amount of time has expired, the portable electronic device performs said destructive action.

51. The security station of claim 40 wherein the security message can be aborted by the portable electronic device.
